(19) United States
(12) Patent Application Publication
(10) Pub. No.: US 2018/0227187 A1
(43) Pub. Date: Aug. 9, 2018

(54) Automatic Network Connection Sharing Among Multiple Streams

(71) Applicant: Prysm, Inc., San Jose, CA (US)

(72) Inventors: Victor Joseph Duvanenko, Carmel, IN (US); Shiloh L. Hawley, Sunnyvale, CA (US)

(73) Assignee: Prysm, Inc., San Jose, CA (US)

(21) Appl. No.: 15/424,725

(22) Filed: Feb. 3, 2017

(51) Int. Cl. H04L 12/24; H04L 29/06; H04L 12/26; H04L 12/825

(52) U.S. Cl. CPC H04L 41/0896; H04L 47/25; H04L 43/0829; H04L 69/04

(57) ABSTRACT

A bandwidth management module on each of multiple appliances in a collaboration environment ensures that the sources, i.e. the appliances that share a common network connection, automatically share the network bandwidth without having to be aware of each other. This is done by having them compete for the available bandwidth in a self-balancing way, such that the stream with the lower bitrate will automatically consume more when extra bandwidth is available, and it will give up less when there is not enough bandwidth.

### BACKGROUND

Shared workspaces may be implemented via a network to support a virtual environment in which users are able to share assets such as applications, content, video conferencing, annotations, and other media across a plurality of appliances. Shared workspaces thus enable users distributed over a variety of geographic locations to collaborate in real time to share thoughts and ideas.

Conventional techniques used to implement the shared workspace provide single and static assets for sharing. Different appliances that participate in the shared workspace, however, may have different characteristics in how the assets are consumed. The appliances, for instance, may have different resolutions, network connections having different amounts of bandwidth, and so forth.

Managing bandwidth in such shared environments can be challenging to say the least. For example, server-side solutions tend to require heavy infrastructure support and communications between multiple different servers. Such can be technically complex and difficult to scale. Problems continue to challenge those who design and implement technology to be used in connection with shared environments.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of a collaboration system operable to employ techniques described herein.

FIG. 2 is a conceptual diagram of a communication infrastructure of the collaboration system of FIG. 1 as sharing content streams across appliances.

FIG. 3 depicts a streaming infrastructure of FIG. 2 in greater detail.

FIG. 4 depicts a messaging infrastructure of FIG. 2 in greater detail.

FIG. 5 depicts a system in an example implementation in which a bandwidth management module can be employed.

FIG. 6 illustrates how available bandwidth can vary over time.

FIG. 7 illustrates how two streams can share bandwidth in accordance with one or more embodiments.

FIG. 8 illustrates how two streams can share bandwidth in accordance with one or more embodiments.

FIG. 9 is a flow diagram depicting a procedure in an example implementation as part of a shared workspace.

FIG. 10 illustrates an example system including various components of an example device that can be implemented as any type of computing device as described and/or utilize with reference to FIGS. 1-9 to implement embodiments of the techniques described herein.

### DETAILED DESCRIPTION

### Overview

In the discussion below, innovative bandwidth sharing techniques are described in conjunction with a so-called “virtual collaboration” between multiple different appliances. It is to be appreciated and understood, however, that the innovative bandwidth sharing techniques can be utilized in any suitable streaming environment and, not necessarily, a virtual collaboration between multiple different appliances. For example, the particular example that is utilized employs User Datagram Protocol (UDP) in a streaming environment to stream data. Accordingly, the innovative techniques can be employed in any suitable UDP streaming environment and, more generally, in any streaming environment in which a server or servers reports data losses, such as data packet drops, to computing devices such as the appliances described below. Alternately, the innovative techniques can be employed in other streaming environments, such as those that stream over TCP, as discussed below.

Shared workspaces enable virtual collaboration of remote and locally connected appliances having a variety of different hardware characteristics, such as tablet computers, wall displays, computing devices, mobile phones, and so forth. These appliances may also include a variety of software having differing characteristics usable to render assets as part of the shared workspace, such as particular word processors, presentation software, drawing applications, and so forth. Examples of assets include documents, images, video conferencing, and so forth as further described in the following.

Virtual collaborations that utilize shared workspaces typically use a network connection to place the remote and locally connected appliances into communication with one another. The network connection can, in many instances, utilize an Internet connection. So, for example, multiple appliances located in one location may participate in a collaboration with multiple appliances located in a separate, remote location. Each location can maintain a network connection to the Internet. A location's network connection may have limited bandwidth which, in turn, can lead to issues when multiple streams of video and/or audio attempt to use the same connection to stream data as part of the collaboration. That is, currently within the collaboration environment, there is no automatic method to share a connection's bandwidth. Bandwidth sharing may work well for a period of time, but there is nothing to prevent one or more stream from attempting to and, in fact, taking over the connection to the detriment of the other streams. This can cause the other streams' bandwidth to starve out, and hence, severely degrade the user's experience.

Techniques are described to support automatic network connection in a shared workspace using appliances having differing hardware and software characteristics, and to support automatic bandwidth adjustment among multiple streams that share a connection, without each stream or corresponding appliance generating the stream having any knowledge about the other streams and bandwidth usage by those other streams.

A virtual collaboration can typically employ one or more large-format appliances and one or more reduced-format appliances. A large-format appliance is typically configured to be mounted to a wall, for instance, and may be feature rich and configured to support a high resolution, network bandwidth, and hardware resources such as memory and processing. This large-format appliance may also include an application configured to consume particular asset formats, such as to support word processing, drawing (e.g., CAD), and so forth. A reduced-format appliance, such as a tablet or mobile phone configured to be held by one or more hands of a user, however, may have reduced resolution, network bandwidth, and hardware resources when compared to the large-format appliance.

In some instances, a large-format appliance may upload, e.g., stream an asset to a service provider for sharing that is configured for consumption via a corresponding application, e.g., a particular word processor. In addition, the reduced-format appliances may also upload or stream assets to the service provider for sharing with other appliances participating in the collaboration. The techniques described herein enable a connection associated with the collaboration to be shared amongst multiple appliances that may or may not be different. Automatic bandwidth adjustment techniques are employed so as to effectively manage the bandwidth associated with a particular shared connection so that data can be streamed, and bandwidth can be managed and coordinated without each stream or associated appliance be knowledgeable of the bandwidth consumption of other streams or appliances sharing the same connection.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

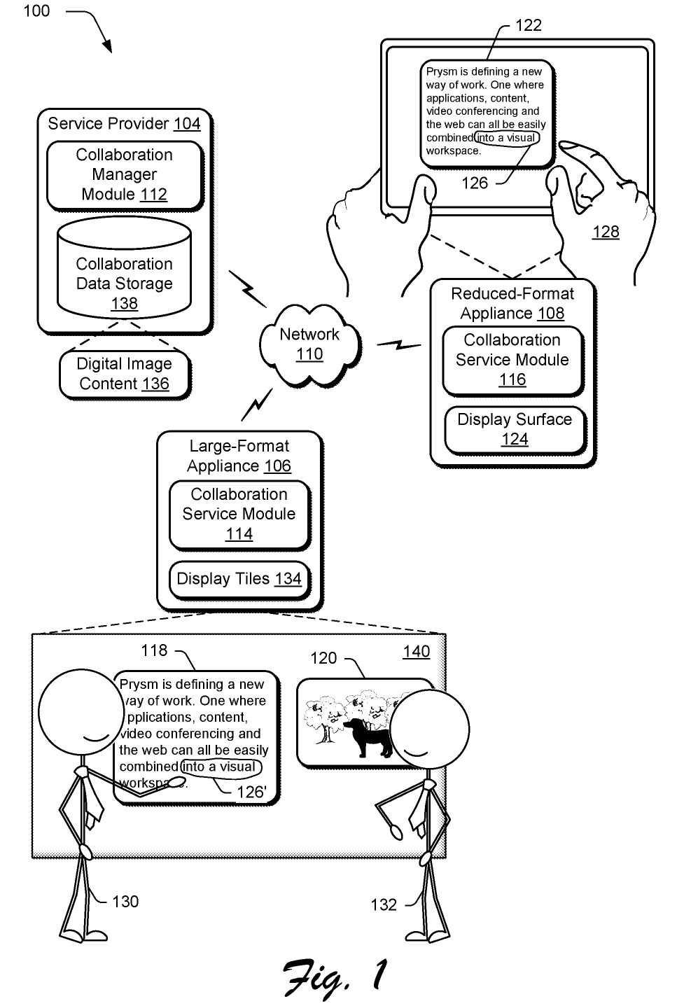

FIG. 1 is an illustration of a collaboration system 100 in an example implementation that is configured to implement one or more aspects of the techniques described herein. As shown, collaboration system 100 includes, without limitation, a service provider 104 and appliances that are used to implement a shared workspace, illustrated examples of which include a large-format appliance 106 and a reduced-format appliance 108, each of which are communicatively coupled via a network 110. Although large and reduced format appliances 106, 108 are described in relation to the following examples, it should be readily apparent that a plurality of appliances may be made up of appliances that support large or reduced formats, solely.

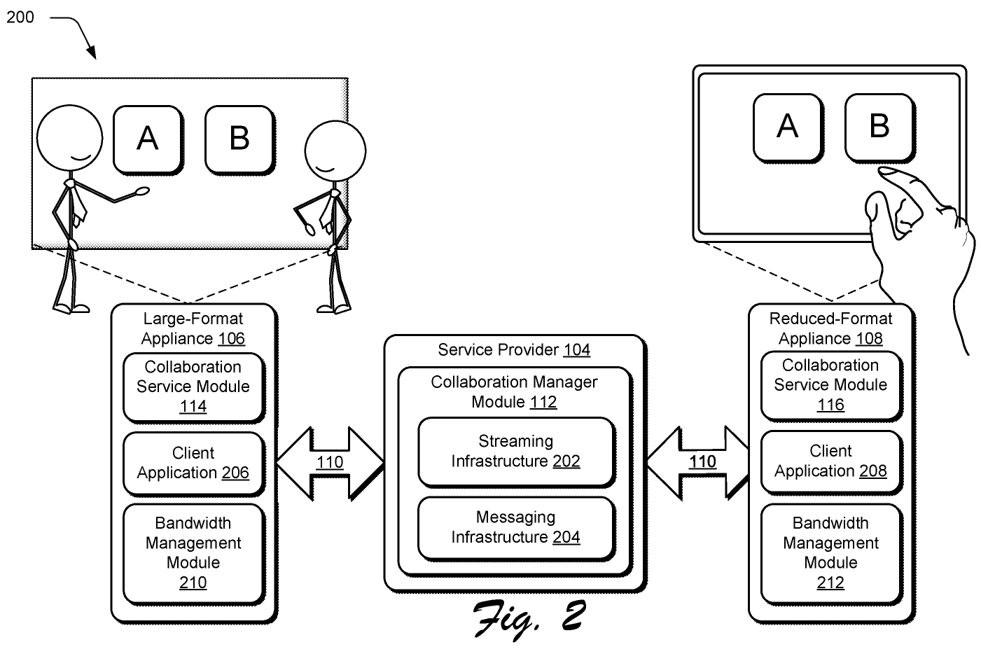

The service provider 104 is illustrated as including a collaboration manager module 112 and the appliances are illustrated as including respective collaboration service modules 114, 116 that together are representative of functionality implemented at least partially in hardware to support a shared workspace of a collaborative environment as further described in the following. Collaboration service modules 114, 116, for instance, may be configured as software such as applications, third-party plug-in modules, webpages, web applications, web platforms, and so on that support participation as part of a shared workspace. The collaboration manager module 112 is representative of functionality (e.g., implemented via software) that is usable to manage this interaction, examples of which are further described in relation to FIGS. 2-4. Although illustrated separately, functionality of the collaboration manager module 112 to manage the shared workspace may also be incorporated by the appliances themselves.

The collaboration service modules 114, 116, for instance, may be implemented as part of a web platform that work works in connection with network content, e.g. public content available via the “web,” to implement a shared workspace. A web platform can include and make use of many different types of technologies such as, by way of example and not limitation, URLs, HTTP, REST, HTML, CSS, JavaScript, DOM, and the like. The web platform can also work with a variety of data formats such as XML, JSON, and the like. Web platform can include various web browsers, web applications (i.e. “web apps”), and the like. When executed, the web platform allows a respective appliance to retrieve assets (e.g., web content) such as electronic documents in the form of webpages (or other forms of electronic documents, such as a document file, XML file, PDF file, XLS file, etc.) from a Web server (e.g., the service provider) for display on a display device in conjunction with the shared workspace.

The shared workspace is configured to share asset and user interactions with those assets. In the context of this disclosure, an “asset” may refer to any interactive renderable content that can be displayed on a display, such as on a display device of the large-format appliance 106 or reduced-format appliance 108, among others. Interactive renderable content is generally derived from one or more persistent or non-persistent content streams that include sequential frames of video data, corresponding audio data, metadata, flowable/reflowable unstructured content, and potentially other types of data.

Generally, an asset may be displayed within a dynamically adjustable presentation window. An example of this is illustrated presentation windows 118, 120 for the large-format appliance 106 and presentation window 122 as displayed for the reduced-format appliance 108. For simplicity, an asset and corresponding dynamically adjustable presentation window are generally referred to herein as a single entity, i.e., an “asset.” Assets may comprise content sources that are file-based, web-based, or Live Source. Assets may include images, videos, web browsers, documents, renderings of laptop screens, presentation slides, any other graphical user interface (GUI) of a software application, and the like.

An asset generally includes at least one display output generated by a software application, such as a GUI of the software application. In one example, the display output is a portion of a content stream. In addition, an asset is generally configured to receive one or more software application inputs. The reduced-format appliance 108, for instance, may include a display device 124 having gesture detection functionality (e.g., a touch sensitive display device, a display device associated with one or more cameras configured to capture a natural user input, and so forth) to capture a gesture, such as an annotation 126 to circle text in a document made by one or more fingers of a user's hand 128.

The annotation is then communicated and displayed on the large-format appliance 106 as annotation 126′ that also circles corresponding text in a presentation window 118 that is viewable by users 130, 132 of that appliance. Thus, unlike a fixed image, an asset is a dynamic element that enables interaction with the software application associated with the asset, for example, for manipulation of the asset. For example, an asset may include select buttons, pull-down menus, control sliders, and so forth that are associated with the software application and can provide inputs to the software application.

As also referred to herein, a “shared workspace” is a virtual digital canvas on which assets associated therewith, and their corresponding content streams, are displayed within a suitable dynamic “viewport window”. Thus, a shared workspace may comprise one or more associated assets (each asset displayed within a presentation window), whereby the entire shared workspace is displayed within a dynamically adjustable viewport window. A shared workspace may be displayed in the entire potential render area/space of a display device of the large-format appliance 106 and/or the reduced-format appliance 108, so that only a single shared workspace can be displayed on the surface thereof In this case, the area of the viewport window that displays the shared workspace comprises the entire render area of the large-format appliance 106 and/or the reduced-format appliance 108. In other implementations, however, the shared workspace and the viewport window may be displayed in a sub-area of the total display area of the large-format appliance 106 and/or the reduced-format appliance 108 that does not comprise the entire render area of respective display devices of these appliances. For example, multiple shared workspaces may be displayed in multiple viewport windows on the large-format appliance 106 and/or the reduced-format appliance 108 concurrently, whereby each shared workspace and viewport window does not correspond to the entire display surface. Each asset associated with a shared workspace, and content stream(s) corresponding to the asset, are displayed in a presentation window according to defined dimensions (height and width) and a location within the shared workspace and viewport window. The asset and presentation window dimensions and location may also be user-adjustable. As also referred to herein, a “project” may comprise a set of one or more related shared workspaces.

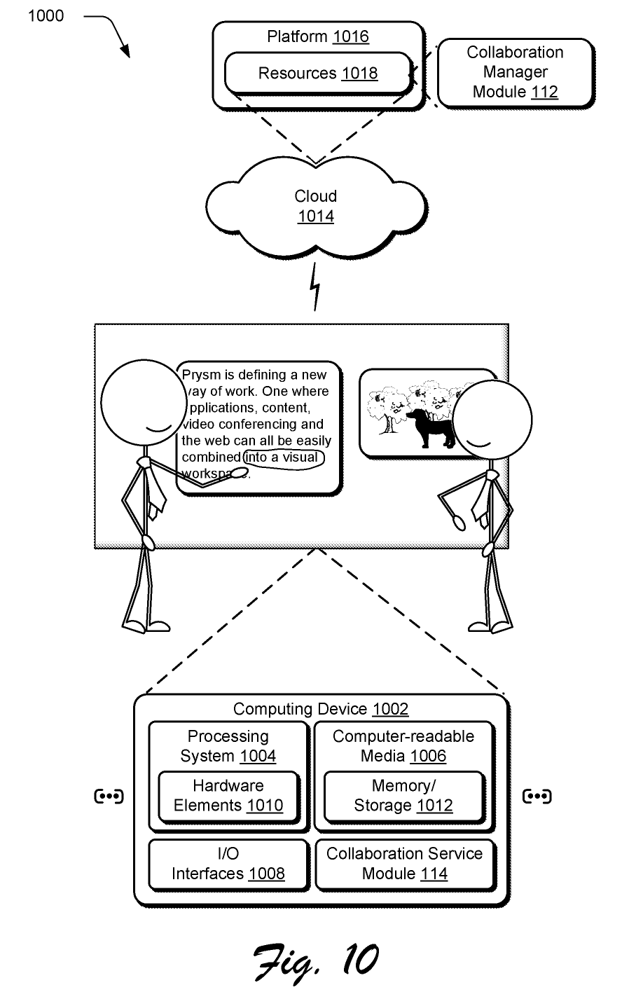

The large-format appliance 106 in this example is formed using a plurality of display tiles 134, e.g., arranged to form a display wall. The service provider 104 includes digital image content 136, which is illustrated as stored in collaboration data storage 136, e.g., using one or more memory devices as further described in relation to FIG. 10. The service provider 104 may receive this digital image content 136 from a variety of sources, such as the reduced-format appliance 108, the large-format appliance 106, remotely via a third-party source via the network 110 (e.g., a website), or from an information network or other data routing device, and converts said input into image data signals. Thus, digital image content 136 may be generated locally, with the large-format appliance 106 or the reduced-format appliance 108, or from some other location. For example, when the collaboration system 100 is used for remote conferencing, digital image content 136 may be received via any technically feasible communications or information network, wired or wireless, that allows data exchange, such as a wide area network (WAN), a local area network (LAN), a wireless (Wi-Fi) network, and/or the Internet, among others as represented by network 110. The service provider 104, reduced-format appliance 108, and large-format appliance 106 may be implemented as one of more computing devices, such as part of dedicated computers, as one or more servers of a server farm (e.g., for the service provider 104 as implementing one or more web services), dedicated integrated circuit, and so on. These computing devices are configured to maintain instructions in computer-readable media and that are executable by a processing system to perform one or more operations as further described in relation to FIG. 10.

Display devices of the large-format appliance 106 and/or the reduced-format appliance 108 may include the display surface or surfaces of any technically feasible display device or system type, including but not limited to the display surface of a light-emitting diode (LED) display, a digital light (DLP) or other projection displays, a liquid crystal display (LCD), optical light emitting diode display (OLED), laser-phosphor display (LPD) and/or a stereo 3D display all arranged as a single stand-alone display, head mounted display or as a single or multi-screen tiled array of displays. Display sizes may range from smaller handheld or head mounted display devices to full wall displays. In the example illustrated in FIG. 1, the large-format appliance 106 includes a plurality of display light engine and screen tiles mounted in an array, which are represented by the display tiles 134.

In operation, the large-format appliance 106 displays image data signals received from the service provider 104. For a tiled display, image data signals 102 are appropriately distributed among display tiles 134 such that a coherent image is displayed on a display surface 138 of the large-format appliance 106. Display surface 140 typically includes the combined display surfaces of display tiles 134. In addition, the display surface 138 of large-format appliance 106 is touch-sensitive that extends across part or all surface area of display tiles 134. In one implementation, the display surface 140 senses touch by detecting interference between a user and one or more beams of light, including, e.g., infrared laser beams. In other implementations, display surface 140 may rely on capacitive touch techniques, including surface capacitance, projected capacitance, or mutual capacitance, as well as optical techniques (e.g., sensor in a pixel), acoustic wave-based touch detection, resistive touch approaches, and so forth, without limitation and thus may detect “touch” inputs that do not involve actual physical contact, e.g., as part of a natural user interface. Touch sensitivity of the display surface 138 enables users to interact with assets displayed on the wall implementing touch gestures including tapping, dragging, swiping, and pinching. These touch gestures may replace or supplement the use of typical peripheral I/O devices, although the display surface 140 may receive inputs from such devices, as well. In this regard, the large-format appliance 106 may also include typical peripheral I/O devices (not shown), such as an external keyboard or mouse.

The display surface 140 may be a “multi-touch” surface, which can recognize more than one point of contact on the large-format appliance 106, enabling the recognition of complex gestures, such as two or three-finger swipes, pinch gestures, and rotation gestures as well as multiuser two, four, six etc. hands touch or gestures. Thus, a plurality of users 130, 132 may interact with assets on the display surface 140 implementing touch gestures such as dragging to reposition assets on the screen, tapping assets to display menu options, swiping to page through assets, or implementing pinch gestures to resize assets. Multiple users 130, 132 may also interact with assets on the screen simultaneously. Again, examples of assets include application environments, images, videos, web browsers, documents, mirroring or renderings of laptop screens, presentation slides, content streams, and so forth. Touch signals are sent from the display surface 140 to the service provider 104 for processing and interpretation. It will be appreciated that the system shown herein is illustrative only and that variations and modifications are possible.

FIG. 2 is a conceptual diagram of a communication infrastructure 200 of the collaboration system 100 of FIG. 1 as sharing content streams across appliances, e.g., across the large and reduced format appliances 106, 108 through interaction with the service provider 104. As shown, this communication infrastructure 200 includes, without limitation, the large-format appliance 106 and the reduced-format appliance 108 communicatively coupled to service provider 104 via a network 110. As shown in FIG. 2, communication infrastructure 200 of this example implementation includes streaming infrastructure 202 and messaging infrastructure 204 included as part of the collaboration manager module 112 to support communication of the collaboration service modules 114, 116 to implement the shared workspace. In this example, large-format appliance 106 includes a collaboration service module 114, one or more client applications 206 and a bandwidth management module 210. Reduced-format appliance 108 includes a collaboration service module 116, one or more client applications 208 and a bandwidth management module 212.

Large-format appliance 106 is illustrated as sharing a content stream A, via communication infrastructure 200, with the reduced-format appliance 108. In response, reduced-format appliance 108 is configured to retrieve content stream A from communication infrastructure 200 and to display that content stream on a display device of the reduced-format appliance 108 with its content stream B. Likewise, reduced-format appliance 108 is configured to share content stream B, via communication infrastructure 200, with the large-format appliance 106. In response, the large-format appliance 106 is configured to retrieve content stream B from communication infrastructure 200 and to display that content stream on a display device of the large-format appliance 106 with its content stream A.

In this fashion, the large and reduced format appliances 106, 108 are configured to coordinate with one another via the service provider 104 to generate a shared workspace that includes content streams A and B. Content streams A and B may be used to generate different assets rendered within the shared workspace. In one embodiment, each of the large and reduced format appliances 106, 108 perform a similar process to reconstruct the shared workspace, thereby generating a local version of that shared workspace that is similar to other local versions of the shared workspace reconstructed at other appliances. As a general matter, the functionality of the large and reduced format appliances 106, 108 are coordinated by respective collaboration service modules 114, 116 and client applications 206, 208, respectively.

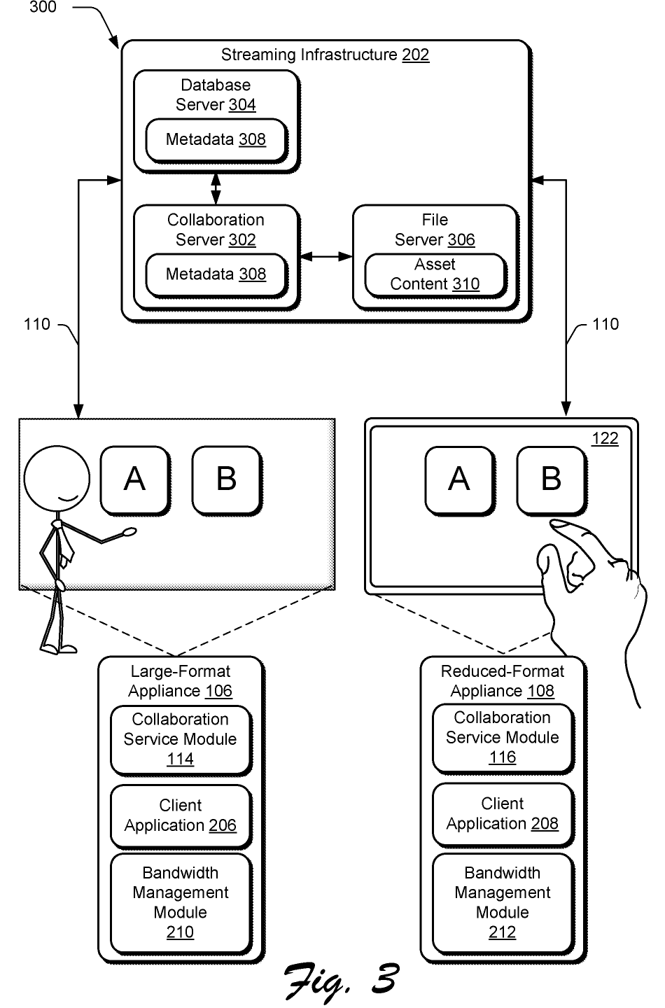

Client applications 206, 208 are software programs that generally reside within a memory (as further described in relation to FIG. 10) associated with the respective appliances. Client applications 206, 208 may be executed by a processing system included within the respective appliances. When executed, client applications 206, 208 setup and manage the shared workspace discussed above in conjunction with FIG. 2, which, again, includes content streams A and B. In one implementation, the shared workspace is defined by metadata that is accessible by both the large and reduced format appliances 106, 108. Each of the large and reduced format appliances 106, 108 may generate a local version of the shared workspace that is substantially synchronized with the other local version, based on that metadata (discussed below in relation to FIG. 3).

In doing so, client application 206 is configured to transmit content stream A to streaming infrastructure 200 for subsequent streaming to the reduced-format appliance 108. Client application 206 also transmits a message to the reduced-format appliance 108, via messaging infrastructure 204, that indicates to the large-format appliance 106 that content stream A is available and can be accessed at a location reflected in the message. In like fashion, client application 208 is configured to transmit content stream B to streaming infrastructure 202 for subsequent streaming to the large-format appliance 106. Client application 208 also transmits a message to the large-format appliance 106, via messaging infrastructure 204, that indicates to the large-format appliance 106 that content stream B is available and can be accessed at a location reflected in the message. The message indicates that access may occur from a location within streaming infrastructure 202.

Client application 206 may also broadcast a message via messaging infrastructure 204 to the reduced-format appliance 108 that specifies various attributes associated with content stream A that may be used to display content stream A. The attributes may include a location/position, a picture size, an aspect ratio, or a resolution with which to display content stream A on the reduced-format appliance 108, among others, and may be included within metadata described below in relation to FIG. 3. Client application 208 may extract the attributes from messaging infrastructure 204, and then display content stream A at a particular position on a display device of the reduced-format appliance 108, with a specific picture size, aspect ratio, and resolution, as provided by messaging infrastructure 204. Through this technique, the large-format appliance 106 is capable of sharing content stream A with the reduced-format appliance 108. The reduced-format appliance 108 is also configured to perform a complimentary technique in order to share content stream B with the large-format appliance 106.

Client applications 206, 208 are thus configured to perform similar techniques in order to share content streams A and B, respectively with one another. When client application 206 renders content stream A on a display device of the large-format appliance 106 and, also, streams content stream B from streaming infrastructure 202, the large-format appliance 106 thus constructs a version of a shared workspace that includes content stream A and B. Similarly, when client application 208 renders content stream B on a display device of the reduced-format appliance 108 and, also streams content stream A from streaming infrastructure 202, the large-format appliance 106 similarly constructs a version of that shared workspace that includes content streams A and B.

The bandwidth management modules 210, 212 are configured to support automatic bandwidth adjustment among multiple streams that share a connection, without each stream or corresponding appliance generating the stream having any knowledge about the other streams and bandwidth usage by those other streams.

The appliances (e.g., the large and reduced format appliances 106, 108) discussed herein are generally coupled together via streaming infrastructure 202 and messaging infrastructure 204. Each of these different infrastructures may include hardware that is cloud-based and/or co-located on-premises with the various appliance, which are both represented by network 110. However, persons skilled in the art will recognize that a wide variety of different approaches may be implemented to stream content streams and transport messages/messages between display systems.

FIG. 3 depicts a block diagram 300 showing the streaming infrastructure 202 of FIG. 2 in greater detail. Streaming infrastructure 202 in this example includes a collaboration server 302, a database server 304, and a file server 306. Each server may comprise a computer device having a processor (such as processing system unit described in relation to FIG. 10) and a computer-readable medium such as memory, the processor executing software for performing functions and operations described herein. Collaboration server 302, database server 304, and file server 306 may be implemented as shown as separate and distinct computing devices/structures coupled to each other and to the appliances via a network 110. Alternatively, functionality of collaboration server 302, database server 304, and file server 306 may be implemented as a single computing device/structure in a single location (e.g., logically or virtually), or in any other technically feasible combination of structures. Further, one or more of collaboration server 302, database server 304, and/or file server 306 may be implemented as a distributed computing system. The network 110 may be via any technically feasible communications or information network, wired or wireless, that allows data exchange, such as a wide area network (WAN), a local area network (LAN), a wireless (WiFi) network, and/or the Internet, among others.

Collaboration server 302 coordinates the flow of information between the various appliances (e.g., the large and reduced format appliances 106, 108), database server 304, and file server 306. Thus, in some implementations, collaboration server 302 is a streaming server for the appliances. In some embodiments, the application program interface (API) endpoint for the appliances and/or business logic associated with streaming infrastructure 202 resides in collaboration server 302. In addition, collaboration server 302 receives requests from appliances and can send notifications to the appliances. Therefore, there is generally a two-way connection between collaboration server 302 and each of appliances, e.g., the large and reduced format appliances 106, 108. Alternatively or additionally, appliances may make requests on collaboration server 302 through the API. For example, during collaborative work on a particular project via collaboration system 100, an appliance may send a request to collaboration server 302 for information associated with an asset to display the asset in a shared workspace of the particular project.

Database server 304 (as well as collaboration server 302) may store metadata 308 associated with collaboration system 200, such as metadata for specific assets, shared workspaces, and/or projects. For example, such metadata may include which assets are associated with a particular shared workspace, which shared workspaces are associated with a particular project, the state of various settings for each shared workspace, annotations made to specific assets, etc. Metadata 308 may also include aspect ratio metadata and asset metadata for each asset. In some implementations, aspect ratio metadata may include an aspect ratio assigned to the project (referred to herein as the “assigned aspect ratio”). An aspect ratio assigned to a project applies to the shared workspaces of the project so that all shared workspaces of the project have the same aspect ratio assigned to the project. Asset metadata for an asset may specify a location/position and dimensions/size of the asset within an associated shared workspace.

The asset metadata indicates the position and size of an asset, for example, implementing horizontal and vertical (x and y) coordinate values. In some embodiments, the asset metadata may express the position and size of an asset in percentage values. In such implementations, the size (width and height) and position (x, y) of the asset is represented in terms of percent locations along an x-axis (horizontal axis) and y-axis (vertical axis) of the associated shared workspace. For example, the position and size of an asset may be expressed as percentages of the shared workspace width and shared workspace height. The horizontal and vertical (x and y) coordinate values may correspond to a predetermined point on the asset, such as the position of the upper left corner of the asset. Thus, when display surfaces of appliances have different sizes and/or aspect ratios, each asset can still be positioned and sized proportional to the specific shared workspace in which is it being displayed. When multiple display devices of multiple appliances separately display a shared workspace, each may configure the local version of the shared workspace based on the received metadata.

File server 306 is the physical storage location for some or all asset content 310 that are rendered as files, such as documents, images, and videos. In some embodiments, file server 306 can receive requests for asset content 310 directly from appliances. For example, an asset, such as a word-processing document, may be associated with a shared workspace that is displayed on a display device of a plurality of appliances, e.g., the large and reduced format appliances 106, 108. When the asset is modified by a user at the large-format appliance 106, metadata for a file associated with the asset is updated in file server 306 by collaboration server 302, the reduced-format appliance 108 downloads the updated metadata for the file from file server 306, and the asset is then displayed, as updated, on the gesture-sensitive display surface 124 of the reduced-format appliance 108. Thus, file copies of all assets for a particular shared workspace and project may be stored at the file server 306, as well as stored at each appliance that is collaborating on a project.

Each of appliances is an instance of a collaborative multi-media platform disposed at a different location in a collaboration system 100. Each collaboration appliance is configured to provide a digital system that can be mirrored at one or more additional and remotely located appliances. Thus, collaboration clients facilitate the collaborative modification of assets, shared workspaces, and/or complete presentations or other projects, as well as the presentation thereof.

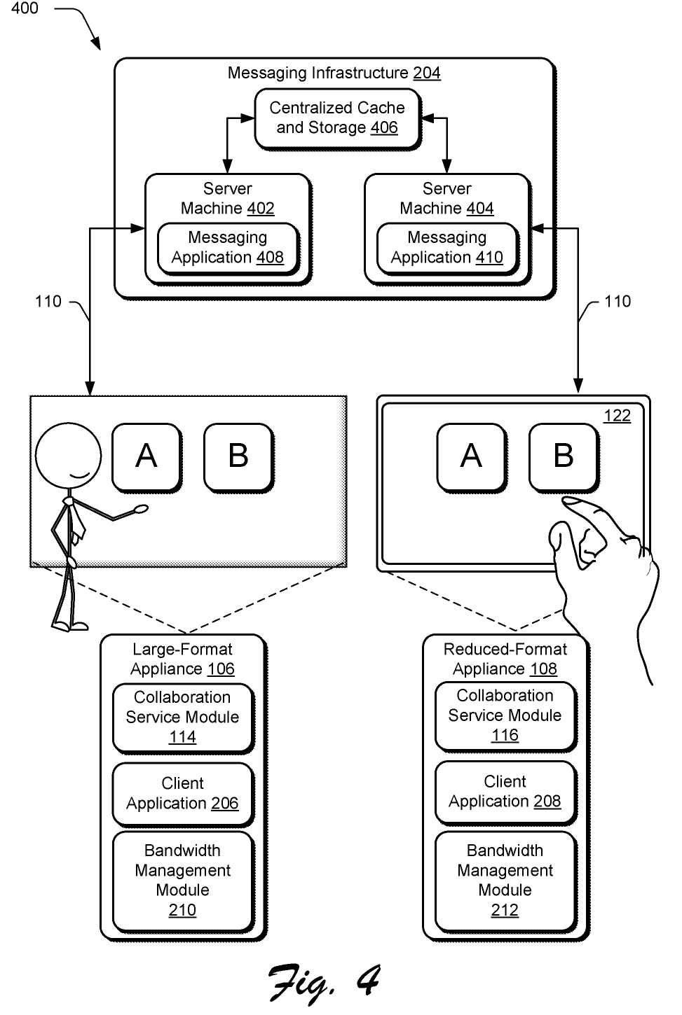

FIG. 4 depicts the messaging infrastructure 204 of FIG. 2 in greater detail. As shown, messaging infrastructure 204 includes server machines 402 and 404 coupled together via centralized cache and storage 406. Server machine 402 is coupled to the large-format appliance 106 and includes a messaging application 408. Server machine 404 is coupled to the reduced-format appliance 108 and includes a messaging application 410.

Server machines 402 and 404 are generally cloud-based or on-premises computing devices that include memory and processing systems as further described in relation to FIG. 10 configured to store and execute messaging applications 408 and 410, respectively. Messaging applications 408 and 410 are configured to generate real-time socket connections with the large and reduced format appliances 106, 108, respectively, to allow messages to be transported quickly between the appliances. In one implementation, messaging applications 408 and 410 are implemented as ASP.NET applications and rely on signalR WebSockets to accomplish fast, real-time messaging.

Centralized cache and storage 406 provides a persistent messaging backend through which messages can be exchanged between messaging applications 408 and 410. In one embodiment, centralized cache and storage includes a Redis cache backed by a SQL database. Messaging applications 408 and 410 may be configured to periodically poll centralized cache and storage 406 for new messages, thereby allowing messages to be delivered to those applications quickly.

In operation, when the large-format appliance 106 transmits a message indicating that content stream A is available on streaming infrastructure 202, as described above, the large-format appliance 106 transmits that message to messaging application 408. Messaging application 408 may then relay the message to centralized cache and storage 406. Messaging application 410 polls centralized cache and storage 406 periodically, and may thus determine that that the message has arrived. Messaging application 410 then relays the message to the reduced-format appliance 108. The reduced-format appliance 108 may then parse the message to retrieve an identifier associated with the large-format appliance 106, and then stream content associated with the large-format appliance 106 from streaming infrastructure 202.

Having considered the example systems above, consider now an example bandwidth manager module in accordance with one or more embodiments.

### Example Bandwidth Module

As noted above, virtual collaborations that utilize shared workspaces typically use a network connection to place the remote and locally connected appliances into communication with one another. The network connection can, in many instances, utilize an Internet connection. So, for example, multiple appliances located in one location may participate in a collaboration with multiple appliances located in a separate, remote location. Each location can maintain a network connection to the Internet. A location's network connection may have limited bandwidth which, in turn, can lead to issues when multiple streams of video and/or audio attempt to use the same connection to stream data as part of the collaboration. That is, currently within the collaboration environment, there is no automatic method to share a connection's bandwidth. Bandwidth sharing may work well for a period of time, but there is nothing to prevent one or more stream from attempting to and, in fact, taking over the connection to the detriment of the other streams. This can cause the other streams' bandwidth to starve out, e.g., become greatly reduced and hence, severely degrade the user's experience.

So, for example, video streams can be streamed from video sources, such as various appliances, to a server in the cloud. The sources are configured to use all available bandwidth, up to a configured “ceiling” bandwidth value, to deliver the highest video quality. The “available bandwidth” refers to the actual total bandwidth that is available for use over a connection, which can vary over time. The site internet connection or an on-premises network each support a certain maximum bandwidth. The “ceiling bit rate”, also referred to as a “target bitrate” is the bit rate at which each stream is streamed given adequate available bandwidth, e.g., one stream may have a target bitrate of 2 mbps while another may have a target bitrate of 5 mbps. These target bitrates can be set by a system administrator.

In systems that stream over User Datagram Protocol (UDP), the server can tell it has lost video frames by looking at sequence numbers encoded in the headers of the video frames it receives. The server can request that a source re-transmit any missing video frames, or portions of video frames. If the server does not receive the retransmitted video frame in a timely fashion, it gives up and moves on, and the frame is considered lost.

The server periodically sends a count of lost frames to the source, and the source uses this information to adjust video compression to match the available bandwidth. When there are no lost frames or retransmit requests from the server, the encoder at the source decreases the amount of compression, thus increasing the video stream bitrate. When the server reports lost frames or sends retransmit requests, the source increases the compression, to provide a lower bitrate stream. In this way, the video quality is kept as high as possible by keeping the bitrate as high as the connection can support.

When there are multiple sources going through the same internet bottleneck to get to the network or server, as in the above-described collaboration environment, it is possible that some video streams could “starve” the others, using the above setup. This is because there is nothing in the scheme to ensure that they share the available bandwidth equally.

For example, suppose the internet connection can support 5 megabits per second (mbps) and there are 2 cameras streaming at exactly 2.5 mbps each. If the available network bandwidth decreases a small amount, a frame could be dropped from camera 1's video stream but not from camera 2's stream, since network events are fairly random. Then, camera 1 will increase video compression, freeing up some bandwidth. Camera 2 on the other hand will decrease compression, as it has not seen any losses, and will use up the bandwidth freed up by camera 1. The next time a frame is lost, it could again be on camera 1's stream, and the inequality would be exacerbated. It is possible to end up with camera 1 having only 0.53 mbps, while camera 2 is receiving 4.5 mbps. In this case both cameras would see themselves using all the bandwidth available to them, but the viewers of stream 1 would have a terrible experience compared with a much better experience for viewers of stream 2.

Another way to look at this problem is that whenever multiple streams reach the maximum bandwidth available, they will end up becoming slightly unbalanced, with one stream losing out. Since this happens quite often it is statistically unlikely to happen an equal number of times to all streams, and thus the bitrate will naturally become unbalanced over time.

One solution to this issue would be for the server to measure cumulative losses over both streams and calculate the amount of video compression the sources should use. The server would tell all video sources to adjust their compression to the same level, and this would guarantee the available bandwidth is shared equally. But this would require the server to know which streams are sharing the same bottleneck up to the server. Further, not all streams coming to the server would be coming from the same location and sharing the same network.

Moreover, even if the server were able to identify which streams were sharing the same internet bottleneck up to the cloud, there would still be a problem, because multiple streams from the same location that need to share the same bandwidth might connect to different servers in the cloud, due to load balancing and scaling of cloud server systems. Thus, the only way then would be for the servers to share information with each other, but this adds a lot of complication which may be impracticable, may not scale well, and may not react fast enough to the dynamic conditions of the internet.

The technical solution described below addresses this technical problem through the use of a bandwidth management module on each appliance. The bandwidth management module ensures that the stream sources, i.e. the appliances that share a common network connection, automatically share the network bandwidth without having to be aware of each other. A common network connection can be analogized to a single pipe through which multiple appliances, typically but not always at a common location such as a conference room, stream data to or through a network. Automatic network bandwidth sharing is done by having the appliances compete for the available bandwidth in a self-balancing way, such that the stream which is furthest from its target bitrate will consume more when extra bandwidth becomes available, and it will give up less when there is not enough bandwidth.

Specifically, when it is necessary for a video source to increase compression, (thereby reducing its bitrate), it will change its bitrate by a given percentage of its current bitrate setting. For example, the corresponding bandwidth management module may decrease its bitrate setting by percentage measurement, e.g., (current bitrate*10%). But, when it is possible for a video source to decrease video compression (thereby increasing its bitrate), it will do so inversely proportional to its current bitrate, for example, increasing bitrate by ((ceiling bitrate−current bitrate)*10%), where ceiling bitrate is the maximum configured bitrate. This is done, in at least some embodiments, by controlling the encoder compression levels to give a particular output bitrate. In this way, the “hungrier” streams, which are the streams furthest away from their own ceiling bitrate, will get more bandwidth whenever there is unused connection bandwidth, and will give up less when there is insufficient available bandwidth. The system, i.e., the appliances, can ascertain that there is available bandwidth when no packets are lost. That is, if the server or servers receiving the streamed data do not indicate that any packets have been dropped, the appliances can ascertain that there is available bandwidth.

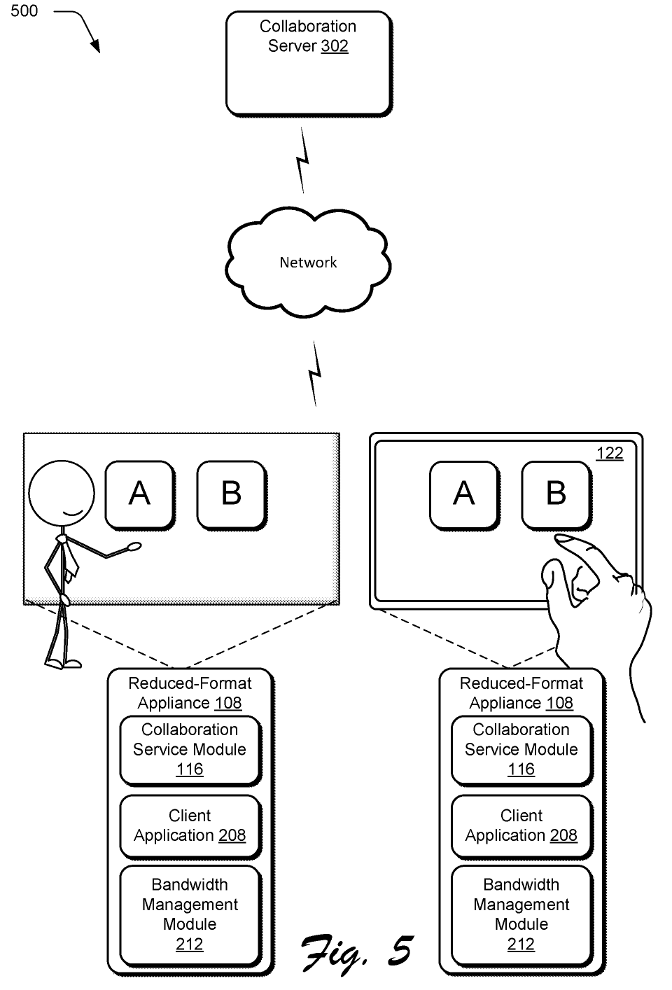

FIG. 5 illustrates an example environment 500 that includes a collaboration server 302 such as that described above, and multiple different reduced-format appliances 108 that are participating in a collaboration from a common location. In this instance, each of reduced-format appliances 108 shares a common network connection through which each can communicate with collaboration server 302. Although only two appliances are illustrated, more than two appliances can be located at any one particular location.

The common network connection that is shared by the reduced-format appliances 108 only has a certain amount of bandwidth available for use. So, for example, if each reduced-format appliance 108 seeks to stream data, such as video or audio data, a limited amount of bandwidth is available to do so. When bandwidth is available for streaming data over the network connection, each reduced-format appliance 108 is free to use the bandwidth that is available. Each reduced-format appliance's bandwidth management module 212 manages each appliance's bandwidth usage in a manner which seeks to manage bandwidth across all appliances sharing a common network connection fairly and equitably, as noted above.

In the illustrated and described embodiment, in the event of a limited bandwidth situation in which the available bandwidth of the common network connection is not enough to enable each of the appliances at a corresponding location to stream data at their corresponding ceiling bit rate, the bandwidth management module adjusts the bandwidth used by the appliance by a proportional amount relative to the appliance's current bit rate. For example, a particular uplink connection for a location may have multiple appliances share the total maximum available network connection bandwidth of 7 mbps. Each of two streams for that particular location may have a ceiling bit rate of 5 mbps. If each stream seeks to transmit data at its ceiling bit rate of 5 mbps, there will not be enough bandwidth for both stream to use. Accordingly, in this situation, data packets from each stream will be dropped and data will be lost, as noted above.

In the illustrated and described embodiment, the bandwidth management module manages its own appliance's bandwidth without knowledge of the bandwidth usage by any other appliances that share the common network connection. The bandwidth management module 212 seeks to adjust a stream's bandwidth by a proportional amount relative to the stream's ceiling bit rate. That is, as a stream gets further from its target bit rate, the bandwidth management module increases the amount of adjustments made to its stream's bit rate when increasing its bandwidth, and decreases the amount of adjustment when decreasing its bandwidth. As a stream gets closer to its ceiling bit rate, the bandwidth management module decreases the amount of adjustments made to its stream's bit rate when increasing its bandwidth, and increases the amount of adjustment when decreasing its bandwidth. For example, when the above-mentioned two 5 mbps streams are sharing the 7 mbps uplink connection, each of the streams wants to stream data at 5 mbps. However, the uplink connection cannot provide that much bandwidth.

At this point, each of the streams will experience dropped packets and, as such, the bandwidth management module for each appliance will start adjusting the corresponding bit rates down from 5 mbps until the corresponding appliance experiences no packet drops. This can be done by employing an equation similar to: (current bitrate*10%) and reducing the current bitrate by this amount. Other approaches can, of course be employed. For example, bitrate can be varied according to the number of lost packets or frames and retransmit requests received in the previous n second, where n is a tunable number. Once the bandwidth of each appliance has been reduced to the point of not experiencing dropped packets, each stream or, more accurately, each appliance's bandwidth management module will begin to adjust the stream's bit rate up by an amount proportional to how far away the actual bit rate is from the target bit rate of 5 mbps. This can be done using an equation similar to: ((ceiling bitrate−current bitrate)*10%). So, for example, if one stream is transmitting at 3 mbps and the other stream is transmitting at 2 mbps, the 2 mbps stream will be adjusted upward by a larger amount than the 3 mbps stream.

Thus, in essence, the stream that is furthest away from its target bit rate can be considered as the “hungriest” of the streams. As such, the hungriest of the streams pushes more aggressively toward its ceiling bit rate than the other streams. Thus, the stream that is closer to its ceiling bit rate is less “hungry” and, accordingly, pushes less hard. This process takes places multiple times with each stream pushing against the other, albeit without knowledge of the other stream. When the forces of each stream equalize pushing against each other, equilibrium is reached with all streams pushing equally hard. In the present example, this would be at an actual bit rate of 3.5 mbps for each of the streams, with bit rates of each stream slowly oscillating around that point.

The above-described approach works equally as well for streams whose target bit rates are not equal. The method also works very well for more than two streams. For example, if one stream is 5 mbps and the other stream is 4 mbps, each appliance's bandwidth management module will adjust the actual bandwidth at which streaming takes place until the first stream transmits at 3.89 mbps and the second stream transmits at 3.11 mbps. This is the point where both streams push with equal forces against each other to divide the overall 7 mbps bandwidth of the network connection.

It is to be appreciated and understood that the above-described bandwidth equilibration process occurs without any coordination between the streams, their corresponding appliances, and their corresponding bandwidth management modules. That is, the streams, corresponding appliances, and corresponding bandwidth management modules know nothing about any of the other streams, corresponding appliances, and corresponding bandwidth modules associated with their location and their common network connection. So, for example, if a new stream starts up, then all of the streams reach a natural balance and share the connection, as described above. That is, the bandwidth management modules on each appliance will likely experience packet drops when a new stream starts streaming thru the shared connection. When this happens, bandwidth adjustments can be made by the bandwidth management module until the bandwidth equilibrates between all the appliances. As the bandwidth of the connection varies, the streams adjust and keep sharing that connection by pushing against each other, always trying to get to their own ceiling bit rate if possible, but backing off as packet losses start to occur.

It is to be appreciated and understood, however, that the above described example has been described as pertaining to an uplink connection. The same or similar approach can be utilized for a downlink connection, for multiple streams sharing network connections, and for video and audio streams as well as other types of streams.

Consider now a couple implementation examples in accordance with one or more embodiments.

### Implementation Example

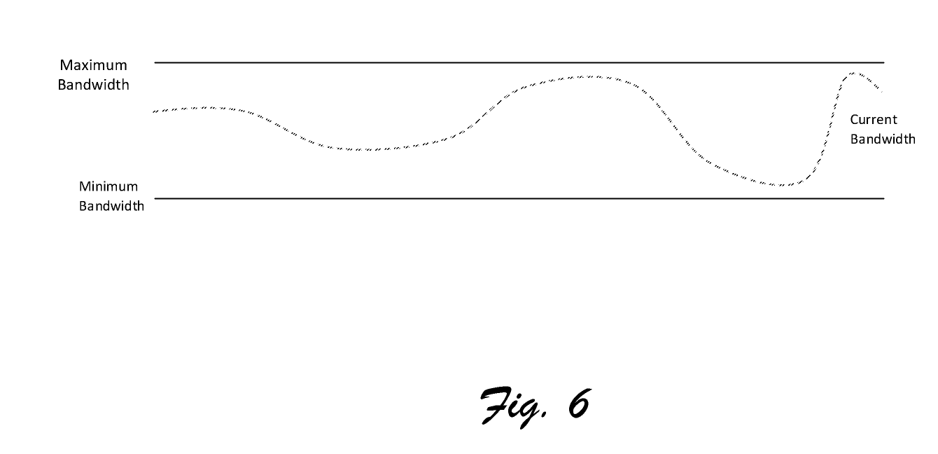

FIG. 6 illustrates the dynamic nature of a network connection between two parties over time. Time is the horizontal axis. Bandwidth is the vertical axis, varying between the minimum and maximum bandwidth available for a particular network connection. The dashed line indicates the current amount of bandwidth available, at a certain point in time. Notice that the current amount of bandwidth available varies over time. Because of this, streams that utilize the corresponding connection will most likely need to adjust their bit rates to account for the variations in available bandwidth.

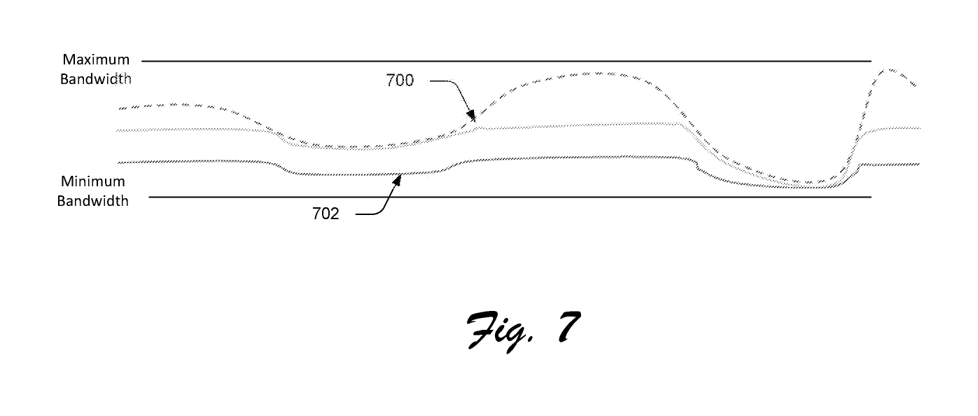

FIG. 7 shows two streams 700, 702 equally sharing the overall bandwidth available for a network connection, up to the ceiling bitrate each stream is configured for. The dashed line indicates the overall available bandwidth of the connection. Stream 700 uses bandwidth between the corresponding line and the line for stream 702 just below. Stream 702 uses bandwidth below the corresponding line for stream 702. Both streams split the available bandwidth nearly equally. Both streams are configured to limit their bandwidth at a certain maximum amount.

When both streams start out (on the left side of the diagram), each stream obtains all of the bandwidth it is configured to use (e.g. 5 mbps each). The dashed line indicates that more bandwidth is available at that time than both streams need (e.g. 15 mbps). As the time progresses (from left to right), available network bandwidth drops to the point where there is not enough bandwidth to satisfy both streams (e.g. 7 mbps). The two streams reduce the amount of bandwidth they use and share the available bandwidth of the connection equally (e.g. 3.5 mbps each). This can be done by increasing the video compression, which reduced the bitrate (bandwidth). Later more bandwidth becomes available and both streams get all of the bandwidth they need (e.g. 5 mbps once again). Later, available bandwidth drops again (e.g. 1 mbps). The two streams share the available bandwidth equally once again.

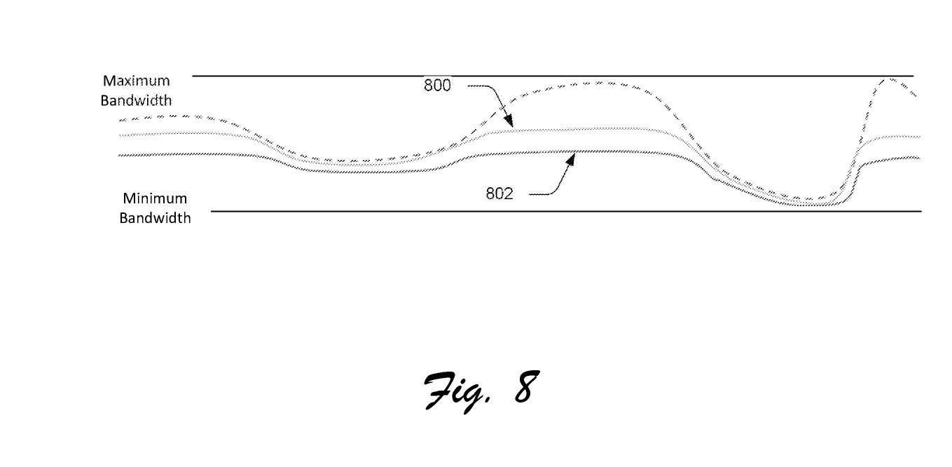

FIG. 8 shows two streams 800, 802 sharing non-equally, the overall bandwidth available for a network connection. Stream 800 uses bandwidth between the corresponding line and the line representing stream 802. Stream 802 uses bandwidth below its corresponding line. Stream 800 is configured to use less bandwidth than Stream 802—e.g. Stream 800 at 2 mbps, and Stream 802 at 4 mbps. Starting on the left side of the diagram, Stream 800 and Stream 802 obtain all of the bandwidth they are configured for (e.g. available bandwidth is 7 mbps). As the available bandwidth drops to 5 mbps, both streams give up equal percentages of their own configured bandwidth. Since the total configured bandwidth is 6 mbps, Stream 800 is ⅓ of the total, and Stream 802 is ⅔ of the total. Thus, when 5 mbps of bandwidth is available the streams share based on their proportions—Stream 800 gets ⅓ of the available bandwidth and Stream 802 gets ⅔ of the bandwidth. Stream 800 gets 1.67 mbps and Stream 802 gets 3.33 mbps of bandwidth—each dropping their bandwidth by 17%. Once more bandwidth becomes available, both streams increase the amount of bandwidth they consume. They can do so using a bitrate increasing computation, such as the one mentioned above, which allows the stream that is furthest away from its ceiling bitrate to more aggressively increase its bitrate. For example, stream 802 is further away from its ceiling bit rate (e.g., 0.67 mbps versus stream 800's 0.33 mbps difference). Accordingly, when more bandwidth becomes available, stream 802's bitrate will be more increased by a larger amount than 800's stream, continuing to achieve equilibrium between the streams, where each stream gives up the same percentage (proportion) of its bandwidth. The same method is applied when more than two streams share a network connection. Also, the method works in the same manner whether multiple streams are on a single computer or multiple computers.

### Example Procedures

The following discussion describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In the illustrated and described embodiment, the operations are performed in a collaborative environment, such as that described above, in which multiple appliances can share a common network connection to participate in a shared workspace in which data can be streamed to other appliances also participating in the shared workspace.

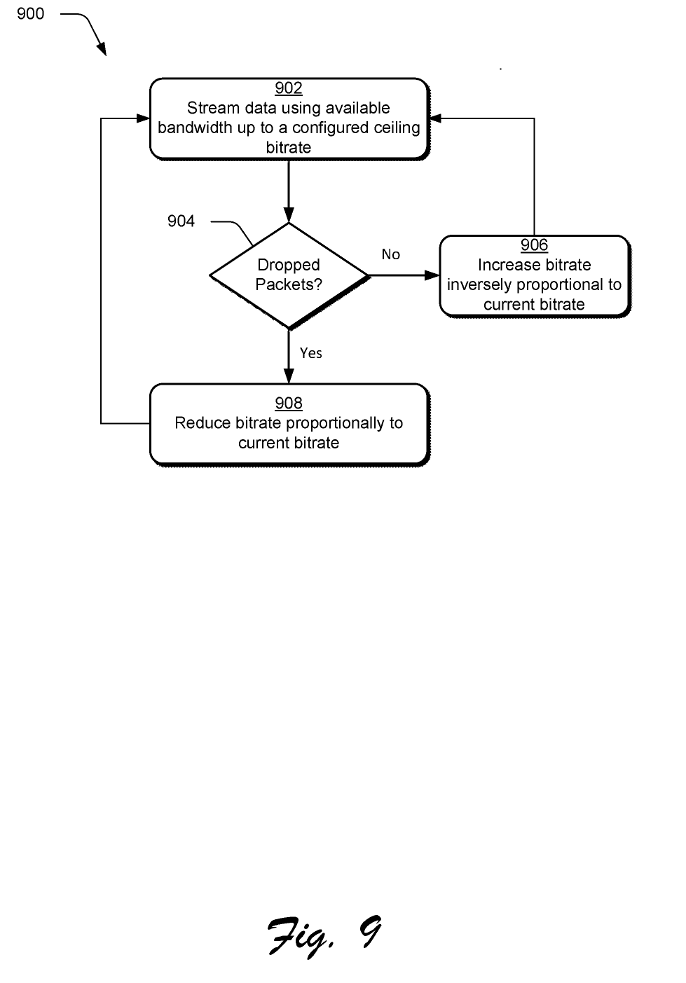

FIG. 9 depicts a procedure 900 in an example implementation in which a network connection can be shared among multiple streams in accordance with one or more embodiments. At block 902, data is streamed using the bandwidth available from a local network connection that is shared amongst appliances participating in a collaboration environment. Each stream is using up to its configured ceiling bitrate. The available bandwidth refers to the bandwidth that is available from the local network connection. In the illustrated and described example, the appliances can utilize User Datagram Protocol (UDP) to transmit data packets to a collaboration server. At block 904, an appliance determines whether any of the packets that have been transmitted have been dropped. This can occur by way of a communication that is received from a corresponding server. Specifically, the server can typically communicate to a particular appliance the number of packets or volume of data that it has received. The corresponding appliance is knowledgeable of the amount of data or packets that were transmitted to the server. By virtue of the communication from the server and the knowledge of what was previously transmitted to the server, the corresponding appliance can ascertain whether any packets were dropped. If no packets were dropped, the corresponding appliance can increase its bitrate inversely proportional to its current bit rate (block 906) under the assumption that there is additional available bandwidth. An example of how this can be done is provided above. The method can then return to block 902 and continue to stream data using its newly-increased bitrate. If, on the other hand, packets were dropped, at block 906, the corresponding appliance can reduce its bitrate proportionally to its current bitrate. An example of how this can be done is provided above. The method can then return to block 902 and continue to stream data using its newly-reduced bitrate. For example, if the total available bandwidth of the connection is 8 mbps, and appliance has a configured ceiling bitrate of 6 mbps, this particular stream starts out streaming at 6 mbps, because the connection has sufficient bandwidth available. If the available bandwidth drops to 5 mbps, then the stream modifies its bit rate to reduce its bandwidth as a percentage of the current bitrate. That is to say, the stream reduces its bitrate by (current bitrate*10%), which is 6 mbps*10%=0.6 mbps, setting the current bitrate to 5.4 mbps. This still exceeds the 5 mbps of the available bandwidth, resulting in dropped packets. So, the stream reduces its bitrate once again by (current bitrate*10%), which it 5.4 mbps*10%=0.54 mbps, setting the current bitrate to 5.4−0.54=4.86 mbps. Now, the available bandwidth exceeds the current bandwidth of the stream, and no packet drops are experienced by the stream. In the illustrated and described embodiment, the bandwidth can be reduced by reducing the bitrate used to stream data. Reducing the bit rate can be performed in any suitable way. For example, in some embodiments, the bitrate can be reduced by changing the amount of compression or resolution or the compression type used to stream the data. Alternately or additionally, the frame rate of data being streamed can be adjusted to reduce the bandwidth.

In the illustrated and described embodiment, bandwidth can be increased by a particular appliance in any suitable way. In at least some embodiments, the further away an appliance is from its target bit rate, the more aggressively bandwidth can be increased. Correspondingly, the closer a particular appliance is to its target bit rate, the less aggressively the bandwidth can be increased. This results in so-called “hungrier” streams increasing their bandwidth more aggressively than less hungry streams. In this manner, bandwidth adjustments can equilibrate in a logical and fair fashion as between different appliances.

Consider now some example extensions of the innovative techniques described above.

### Example Extensions

As noted above, the innovative techniques can be employed in connection with protocols other than UDP. For example, the innovative techniques can be employed in connection with data streaming using Transmission Control Protocol (TCP), which does not expose packet losses to the users of the protocol. In this instance, bandwidth availability can be determined by analyzing the queue length of packets waiting to be sent out. When transmission is above the available bandwidth, the queue length will increase. When transmission is below the available bandwidth, the queue length will be small. In this instance, the self-balancing aspect between data streams would work exactly as described above. However, only the method of determining available bandwidth would change.

As another extension, the above-described techniques can be utilized not only to stream data up to the “cloud”, as in the above examples, but the techniques can be employed to stream data down from the “cloud”. So, for example, data streams can be pre-encoded at different compression levels. Thus, responsive to changes in available bandwidth, different pre-encoded streams of the same data can be switched between. Accordingly, if bandwidth becomes limited relative to two users in the same household watching different movies, streaming source can be informed and, responsively, switch to a different pre-encoded stream to mitigate the limited bandwidth. That is, in this example, a communication channel is opened between the streaming source, e.g. a server, and a destination, e.g., a household with multiple different devices that can consume streamed data. Video data can be streamed and can include sequence numbers. If a sequence number or multiple sequence numbers are determined to be missing at the destination, the streaming source can be informed and, as such, can select a different pre-encoded stream to mitigate the limited bandwidth.

### Example System and Device

FIG. 10 illustrates an example system generally at 1000 that includes an example computing device 1002 that is representative of one or more computing systems and/or devices that may implement the various techniques described herein. This is illustrated through inclusion of the collaboration service module 114 and collaboration manager module 112. The computing device 1002 may be, for example, a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O interface 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1006 is illustrated as including memory/storage 1012. The memory/storage 1012 represents memory/storage capacity associated with one or more computer-readable media. The memory/storage component 1012 may include volatile media (such as random access memory (RAM)) and/or nonvolatile media (such as read only memory (ROM), Flash memory, optical disks, magnetic disks, and so forth). The memory/storage component 1012 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1002, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of a module that is executable by the computing device 1002 as software may be achieved at least partially in hardware, e.g., through use of computer-readable storage media and/or hardware elements 1010 of the processing system 1004. The instructions and/or functions may be executable/operable by one or more articles of manufacture (for example, one or more computing devices 1002 and/or processing systems 1004) to implement techniques, modules, and examples described herein.

The techniques described herein may be supported by various configurations of the computing device 1002 and are not limited to the specific examples of the techniques described herein. This functionality may also be implemented all or in part through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 may include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 may abstract resources and functions to connect the computing device 1002 with other computing devices. The platform 1016 may also serve to abstract scaling of resources to provide a corresponding level of scale to encountered demand for the resources 1018 that are implemented via the platform 1016. Accordingly, in an interconnected device embodiment, implementation of functionality described herein may be distributed throughout the system 1000. For example, the functionality may be implemented in part on the computing device 1002 as well as via the platform 1016 that abstracts the functionality of the cloud 1014.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A bandwidth sharing method comprising:
streaming, from an appliance and using a current bitrate, data using bandwidth available from a common network connection that can be shared amongst one or more other appliances;
determining, by the appliance, that one or more data packets associated with the streamed data have been dropped;
responsive to one or more data packets having been dropped, reducing bitrate, used by the appliance to stream data, proportionally to the current bit rate; and
continuing to stream data at the reduced bitrate.

2. The method as described in claim 1 further comprising after said continuing to stream data at the reduced bitrate, continuing to reduce the reduced bitrate responsive to one or more packets being dropped.

3. The method as described in claim 2 further comprising responsive to ascertaining that no packets have been dropped, increasing bit rate inversely proportional to a current bitrate used to stream data.

4. The method as described in claim 1 further comprising responsive to ascertaining that no packets have been dropped, increasing bit rate inversely proportional to a current bitrate used to stream data.

5. The method as described in claim 1, wherein said reducing bitrate is performed by changing an amount of compression used to stream data.

6. The method as described in claim 1, wherein said reducing bitrate is performed by changing a compression type used to stream data.

7. The method as described in claim 1, wherein said streaming data is performed by using User Datagram Protocol (UDP) to stream said data.

8. The method as described in claim 1, wherein said determining is performed responsive to receiving a communication from a server to which said data is streamed.

9. A system implemented in a collaborative environment in which multiple appliances can share a common network connection to participate in a shared workspace in which data can be streamed to other appliances also participating in the shared workspace, the system comprising:
an appliance;
one or more processors associated with the appliance;
one or more computer-readable media storing computer-executable instructions which, when executed by the one or more processors implement a bandwidth management module configured to enable the appliance to stream data as part of the shared workspace, the bandwidth management module configured to perform operations comprising:
streaming, from the appliance and using a current bitrate, data using bandwidth available from the common network connection that can be shared amongst one or more other appliances;
determining, by the appliance, that one or more data packets associated with the streamed data have been dropped;
responsive to one or more data packets having been dropped, reducing bitrate, used by the appliance to stream data, proportionally to the current bit; and
continuing to stream data at the reduced bitrate.

10. The system as described in claim 9 further comprising after said continuing to stream data at the reduced bitrate, continuing to reduce the reduced bitrate responsive to one or more packets being dropped.

11. The system as described in claim 10, further comprising responsive to ascertaining that no packets have been dropped, increasing bit rate inversely proportional to a current bitrate used to stream data.

12. The system as described in claim 9 further comprising responsive to ascertaining that no packets have been dropped, increasing bit rate inversely proportional to a current bitrate used to stream data.

13. The system as described in claim 9, wherein said reducing bitrate is performed by changing an amount of compression used to stream data.

14. The system as described in claim 9, wherein said reducing bitrate is performed by changing a compression type used to stream data.

15. The system as described in claim 9, wherein said streaming data is performed by using User Datagram Protocol (UDP) to stream said data.

16. The system as described in claim 15, wherein said determining is performed responsive to receiving a communication from a server to which said data is streamed.

17. One or more computer-readable media storing computer-executable instructions which, when executed by the one or more processors, perform operations comprising:
streaming, from an appliance participating in a collaborative environment in which multiple appliances can share a common network connection to participate in a shared workspace in which data can be streamed to other appliances also participating in the shared workspace, data using bandwidth available from the common network connection that can be shared amongst one or more other appliances participating in the collaborative environment;
determining, by the appliance participating in the collaborative environment, that one or more data packets associated with the streamed data have been dropped; and
responsive to one or more data packets having been dropped, reducing bitrate, used by the appliance to stream data, proportionally to the current bit; and
continuing to stream data at the reduced bitrate.

18. The one or more computer-readable media as described in claim 17, further comprising after said continuing to stream data at the reduced bitrate, continuing to reduce the reduced bitrate responsive to one or more packets being dropped.

19. The one or more computer-readable media as described in claim 18, further comprising responsive to ascertaining that no packets have been dropped, increasing bit rate inversely proportional to a current bitrate used to stream data.

20. The one or more computer-readable media as described in claim 17, further comprising responsive to ascertaining that no packets have been dropped, increasing bit rate inversely proportional to a current bitrate used to stream data.
